(19) United States
(12) Patent Application Publication
(10) Pub. No.: US 2025/0173147 A1
(43) Pub. Date: May 29, 2025

(54) Method to Translate Natural Language Instructions into System I/O Commands Using Spatial-Textual Screen Context (STSC)

(71) Applicant: Shaoheng Wang, Toronto (CA)

(72) Inventor: Shaoheng Wang, Toronto (CA)

(21) Appl. No.: 18/894,844

(22) Filed: Sep. 24, 2024

Related U.S. Application Data
(60) Provisional application No. 63/603,004, filed on Nov. 27, 2023.

(51) Int. Cl. G06F 9/30; G06V 20/50; G06V 30/10

(52) U.S. Cl. CPC G06F 9/3017; G06V 20/50; G06V 30/10

(57) ABSTRACT

The present invention relates to a computer-implemented system for translating natural language instructions into precise input and output (I/O) commands. The innovative system integrates a computer vision module that captures and analyzes visual elements from a user interface with a high-performance language model that interprets the elements to generate contextually relevant action descriptions. The descriptions are refined by integrating specific screen coordinates, ensuring accuracy and precision in the resulting instructions. The refined instructions are then converted into actionable I/O commands, allowing intuitive interaction with the device through natural language input. The method significantly enhances human-computer interaction, especially for individuals with disabilities by enabling efficient control through natural language. It represents a significant advancement in artificial general intelligence by converting complex linguistic instructions into concrete system actions with broad potential applications across various technological fields.

### CROSS-REFERENCE TO RELATED APPLICATION

This disclosure claims the benefit of the priority of U.S. Provisional Patent Application No. 63/603,004, entitled “A Method to Translate Natural Language Instructions into System I/O Commands Using Spatial-Textual Screen Context (STSC)” and filed on Nov. 27, 2023. The above-identified application is incorporated herein by reference in its entirety.

### TECHNICAL FIELD

The present invention pertains to the field of human-computer interaction, specifically focusing on the translation of natural language instructions into system input/output commands by incorporating advancements in the domains of artificial intelligence, computer vision, and natural language processing to facilitate intuitive and efficient computer operation.

### BACKGROUND

The background description includes information that may be useful in understanding the present invention. It is not an admission that any of the information provided herein is prior art or relevant to the presently claimed invention, or that any publication specifically or implicitly referenced is prior art.

Existing technologies in the realm of human-computer interaction largely rely on traditional input methods such as keyboards, mouse, and basic voice commands. The tools have served general computing needs well but often fail to address the requirements of individuals with disabilities. For the users with disabilities, the standard input devices like keyboards, mouse etc., may be difficult or impossible for some users to operate, and basic voice command systems often struggle with nuanced or complex commands. Additionally, the pre-existing methods typically lack the adaptability needed to cater to diverse user needs and scenarios, making them less inclusive and versatile. The inadequacy highlights a broader issue. The integration of artificial intelligence (AI) into computer operations has so far been constrained to specific tasks with predefined parameters. While AI has significantly enhanced the functionality of many systems, the applications have largely been limited to relatively narrow domains. As a result, the AI systems lack the adaptability and versatility necessary for a more comprehensive approach to human-computer interaction.

Recent progress in artificial general intelligence (AGI) has introduced new possibilities, particularly in integrating advanced technologies like computer vision and sophisticated language models. The advancements have the potential to significantly enhance human-computer interactions by enabling systems to better interpret and process complex instructions. However, despite the technological strides significant challenges remain. One of the main issues is that current systems still struggle with translating complex, natural language instructions into executable commands. They often fail to grasp the full context of human language or interpret spatially-oriented instructions accurately. The limitation prevents the systems from performing more complex tasks autonomously, thus constraining their overall effectiveness and utility.

Despite of the advancements, there is a pressing need for innovative solution that addresses the limitations, particularly to enhance accessibility for individuals with disabilities. One of the key areas of improvement would be the development of system that is capable of controlling computers through natural language voice commands that are not only contextually aware but also sensitive to the spatial and textual layout of the screen. Such a system would represent a major advancement in human-computer interaction, moving beyond the limitations of current technology. By enabling more intuitive and responsive interactions, the approach would greatly benefit individuals with disabilities, providing them with greater autonomy and a more user-friendly computing experience.

### SUMMARY

The present invention introduces a novel system or method to convert natural language instructions into system input and output commands by utilizing spatial-textual screen context (STSC). The innovative approach addresses the limitations of traditional systems by integrating advanced developments in computer vision and language processing. By leveraging STSC, the system transforms complex contextually rich tasks into actionable commands that computers can understand and execute with a level of precision similar to human comprehension. The advancement represents a significant leap forward in both accessibility and artificial general intelligence (AGI). For individuals with disabilities, it offers a crucial enhancement in accessibility, allowing for more intuitive and effective control of computer systems. For the broader field of AGI, it marks a pivotal step towards creating systems that can understand and interact with human language in a more sophisticated and context-aware manner.

In an embodiment of the present invention, the invention discloses a computer-implemented method for translating a natural language instruction into an input and output (I/O) command. The method leverage advanced technology to enhance user interaction with electronic devices. The method discloses an advanced computer vision module configured to capture and analyse a plurality of visual elements from a user interface of an electronic device. The computer vision module understands the spatial arrangement and textual content displayed on the screen, thereby creating a comprehensive visual context of the interface. The data captured by the computer vision module is then inputted into an advanced language model. The model is configured to interpret the visual information and generate a natural language description of potential actions that are contextually relevant to the user interface. The output of the language model comprises of natural language instructions that specify actions tailored to the current context and user requirements. The instructions are further refined by integrating the instructions with specific screen coordinates which enhances both the contextual relevance and spatial accuracy of the actions. The step of refining ensures that the instructions are not only aligned with the user's needs but also correspond precisely to locations on the screen where the actions should be performed. The refined instructions are then translated into a precise system I/O commands. The commands include actionable directives that correspond to specific screen coordinates, enabling users to interact with the interface through natural language in a manner that is intuitive and efficient.

In one of the embodiment of the present invention, the method enhances human-computer interaction by enabling a seamless collaboration between the computer vision module and the language model, resulting in a more intuitive and efficient user experience.

In one of the embodiment of the present invention, the system I/O commands generated are particularly suited for facilitating interaction with computer interfaces for individuals with disabilities, thereby expanding accessibility and usability of technology.

In one of the embodiment of the present invention, the integration of computer vision and language processing represents a notable advancement in artificial general intelligence providing a robust framework for converting complex linguistic instructions into concrete system actions.

In an embodiment of the present invention, the invention depicts a computer-implemented system employing an Observe, Think, Act (OTA) Architecture to effectively translate natural language instructions into an actionable system input/output (I/O) commands. The system includes an Observe module, a Think module, and an Act module that works in collaboration to seamlessly convert a complex linguistic instruction into a precise system action. In the embodiment, the Observe module employs an advanced computer vision component to capture and analyse a plurality of visual elements of a user interface. Further, the think module leverages an advanced language model that processes the visual information provided by the Observe module by using a natural language processing techniques. The think module generates a natural language descriptions and potential actions based on the current context and spatial-textual information of the user interface. Additionally, the system utilizes an act module for refining the natural language instructions produced by the Think module by incorporating specific screen coordinates.

In an embodiment of the present invention, the invention discloses a computer-implemented software for translating natural language instructions into executable system input/output (I/O) commands. The software integrates a range of advanced components and technologies to create an effective and intuitive system for human-computer interaction. The software comprises a user interface component developed using React to provide a cross-platform interface for users to input natural language instructions and view the results of the translated system I/O commands. Behind the interface, the Backend service coded in Python orchestrates a variety of essential tasks that includes data processing, computer vision tasks, system I/O management, and server interactions that provides a robust foundation for the software's operations. In addition, a software language model is integrated via a Lang Chain to optimize memory management. Further, the software incorporates a similarity search and clustering component using a Faiss module to perform fast and accurate similarity searches within large-scale vector data that is crucial for matching query vectors with stored vectors in the vector database. Moreover, to handle visual data the software includes an optical character recognition (OCR) component that employs tesseract OCR for extracting text from images. Additionally, an object detection module utilizes Yolo component to enhance the software's ability of detecting and understanding various user interface elements in real time. The software's architecture is bolstered by an API integration that facilitates communication between the front-end user interface and the backend service. A cloud hosting and server management is handled by a vercel server. For mobile users, the software encapsulates Firebase module which provides a user authentication, a device management, and a cross-device messaging. On the backend, complex tasks such as OCR, object detection, and system I/O command execution are managed through pc back end, with any scale endpoints providing access to large language model services. The software also incorporates an intelligent indexing template to translate natural language instructions into specific I/O commands, enhancing precision and clarity. A self-reflection mechanism through a self-reflection template allows the system to analyse completed actions, generates new knowledge and updates a lessons learned database for facilitating continuous improvement.

In one of the embodiments of the present invention, the integration of the user interface, backend service, language models, OCR and object detection modules, along with API and cloud service interactions, collectively contribute to the accurate translation of natural language instructions into precise system I/O commands, elevating the efficacy and intuitiveness of human-computer interaction.

In one of the embodiments of the present invention, the modular design and component-based architecture enable adaptability and customization, allowing for seamless integration with various technologies and platforms, thereby broadening the applicability of the software in diverse technological domains.

In one of the embodiments of the present invention, the integration of advanced computational techniques represents a significant contribution to the field of artificial general intelligence, enabling a more nuanced and contextually aware interpretation of natural language instructions.

For further clarification of the features and other embodiments of the invention, a more particular description is provided that will further explain the features and advantage of the invention with the illustration or the drawings. As will be appreciated, other embodiments of the present invention are possible utilizing, alone or in combination, one or more of the features set forth above or described in detail below.

### BRIEF DESCRIPTION OF THE DRAWINGS

A full understanding of the invention can be gained from the following description of the preferred embodiments when read in conjunction with the accompanying drawings in which:

FIG. 1 illustrates an overview of components of the OTA architecture diagram, in according to embodiments of the present invention disclosed herein;

FIG. 2 illustrates a block diagram of the lesson learned database components, in according to embodiments of the present invention disclosed herein;

FIG. 3 illustrates a block diagram of computer vision context components, in according to embodiments of the present invention disclosed herein;

FIG. 4 illustrates a block diagram of the OTA brain, in according to embodiments of the present invention disclosed herein;

FIG. 5 illustrates a block diagram of priority action queue scheduling, in according to embodiments of the present invention disclosed herein;

FIG. 6 illustrates a block diagram of high level processing flow, in according to embodiments of the present invention disclosed herein;

FIG. 7 illustrates a block diagram of the translator components interaction, in according to embodiments of the present invention disclosed herein;

FIG. 8 illustrates a block diagram of actor components interaction, in according to embodiments of the present invention disclosed herein;

FIG. 9 illustrates a block diagram of retrospective components interaction, in according to embodiments of the present invention disclosed herein;

FIG. 10 illustrates a block diagram of the prompt input pre-processing, in according to embodiments of the present invention disclosed herein

FIG. 11 illustrates a block diagram of the composition of existing knowledge, in according to embodiments of the present invention disclosed herein;

FIG. 12 illustrates a block diagram of the preparation of vectorized knowledge, in according to embodiments of the present invention disclosed herein;

FIG. 13 illustrates a block diagram of knowledge query from a vector database, in according to embodiments of the present invention disclosed herein;

FIG. 14 illustrates a block diagram of textual OCR screen context, in according to embodiments of the present invention disclosed herein;

FIG. 15 illustrates a block diagram of spatial OCR screen context, in according to embodiments of the present invention disclosed herein;

FIG. 16 illustrates a block diagram of spatial UI screen context, in according to embodiments of the present invention disclosed herein;

FIG. 17 illustrates a perspective view of spatial context components, in according to embodiments of the present invention disclosed herein;

FIG. 18 illustrates a perspective view of spatial-textual screen context, in according to embodiments of the present invention disclosed herein;

FIG. 19 illustrates a perspective view of textual screen reconstruction, in according to embodiments of the present invention disclosed herein;

FIG. 20 illustrates a perspective view of control brain behavior using system prompt, in according to embodiments of the present invention disclosed herein;

FIG. 21 illustrates a perspective view of intelligent indexing, in according to embodiments of the present invention disclosed herein;

FIG. 22 illustrates a perspective view of element parser, in according to embodiments of the present invention disclosed herein;

FIG. 23 illustrates a perspective view of self-learning with new knowledge system, in according to embodiments of the present invention disclosed herein;

FIG. 24 illustrates a perspective view of high level software components interaction diagram, in according to embodiments of the present invention disclosed herein;

FIG. 25 illustrates a perspective view of mobile message flow, in according to embodiments of the present invention disclosed herein;

FIG. 26 illustrates a perspective view of firebase service flow, in according to embodiments of the present invention disclosed herein;

FIG. 27 illustrates a perspective view of PC Frontend Service Flow, in according to embodiments of the present invention disclosed herein;

FIG. 28 illustrates a perspective view of PC Backhand Service Flow, in according to embodiments of the present invention disclosed herein;

FIG. 29 illustrates a block diagram of Operating Computer using Voice Commands, in according to embodiments of the present invention disclosed herein;

FIG. 30 illustrates a block diagram of OTA architecture combined with API's, in according to embodiments of the present invention disclosed herein;

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

References will now be made in detail to the presently preferred embodiments of the invention, examples of which are illustrated in the accompanying drawings. Throughout the following detailed description, the same reference numerals refer to the same elements in all figures.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and it is not intended to be limiting the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the following description, reference will be made to the accompanying drawing, in which comparable functional elements are designated with like numerals. The aforementioned accompanying drawings show by way of illustration and not by the way of limitation, specific aspects and implementations consistent with principles of this disclosure. These implementations are described in sufficient detail to enable those skilled in the art to practice the disclosure and it is to be understood that other implementations may be utilized, and that structural changes and/or substitutions of various elements may be made without departing from the scope and spirit of this disclosure. The following detailed description is, therefore, not to be construed in limited sense. It is noted that description herein is not intended as an extensive overview, and as such, concepts may be simplified in the interests of clarity and brevity. All documents mentioned in this application are hereby incorporated by reference in their entirety.

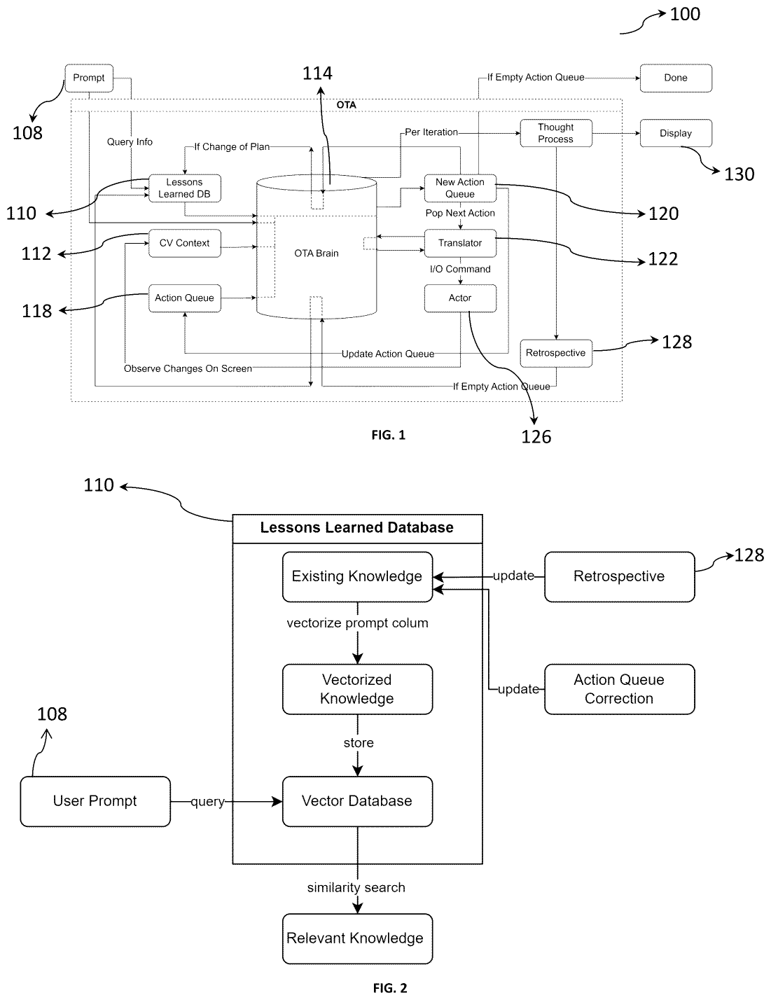

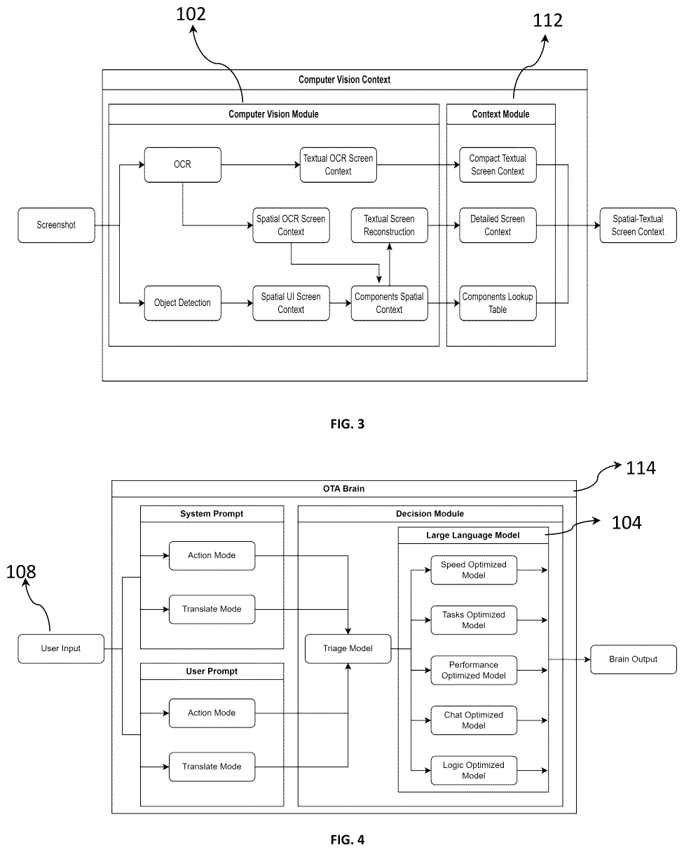

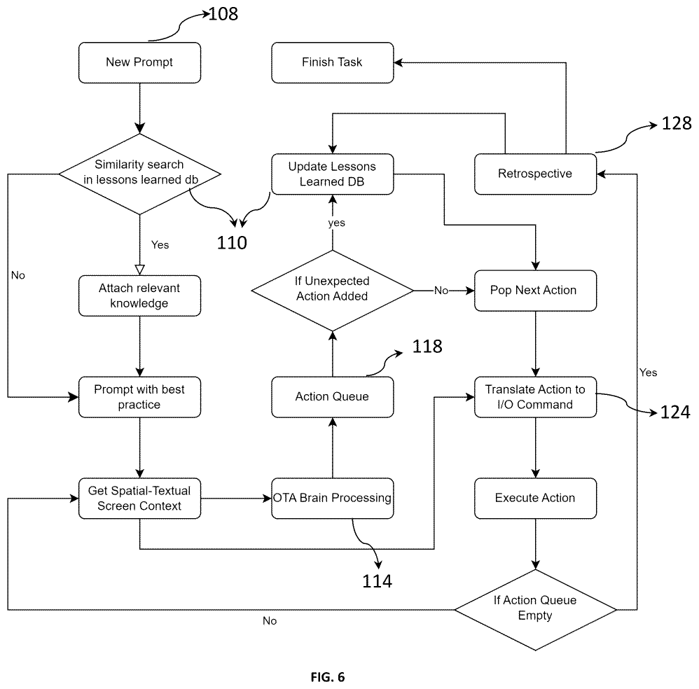

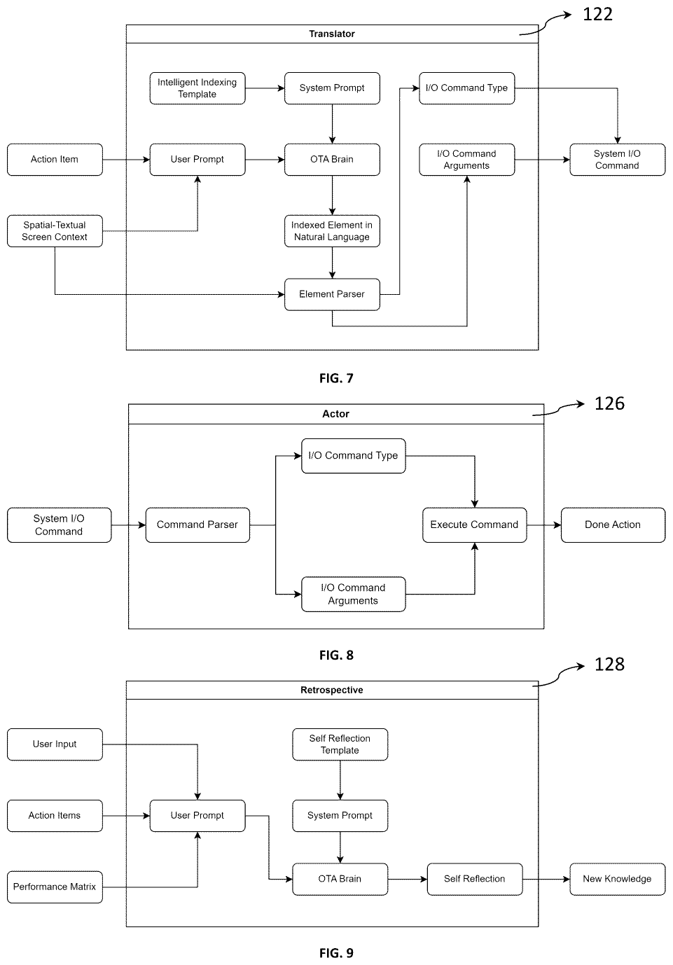

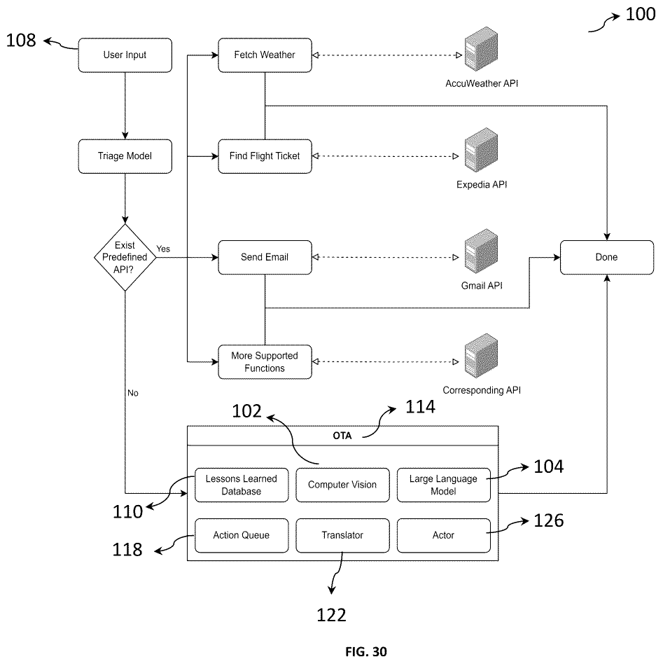

According to the embodiment of the present invention, the FIG. 1-FIG. 9 and FIG. 30 depicts an overview of all the components involved in translating natural language instructions into system input/output commands. The computer-implemented method 100 integrates several advanced components including a computer vision module 102, a natural language processing model 104, and a dynamic action management system 106 to provide an efficient interface between users and their devices. The method 100 depicts a user providing a natural language prompt 108 that may include “sending an email” or “checking the weather”. The prompt serves as the primary input for the system. Upon receiving the prompt, the system first queries a Lessons Learned Database (DB) 110 having stored previous interactions and instructions. The database 110 plays a crucial role by offering historical insights and context that can guide the interpretation and execution of the current instruction. By leveraging past data, the system gains a foundational understanding that helps in tailoring responses and actions relevant to the current prompt. In the embodiment, a CV context module 112 and an advanced computer vision module 102 works together to capture and analyse the current visual state of a user interface. The modules observe various elements on the screen including layout, text, and graphical components to build a comprehensive visual context. Understanding of the spatial arrangement and the textual content on the interface is essential for generating contextually appropriate commands. In addition, a observe, think and act module 114 (i.e. OTA) integrates inputs from the Lessons Learned DB 110, the CV Context module 112, the user's prompt 108, and a current action queue 116 that is a part of the action queue management system 106. The OTA Brain 114 is responsible for evaluating the information received from different modules to determine the most appropriate actions. The OTA 114 uses an advanced language model 104 to interpret the visual data and the user's request 108, thereby generating natural language descriptions of potential actions that align with the current context. The language model 104 is used for translating the visual and textual information into actionable instructions. Once the OTA Brain 114 has identified the necessary actions, then the actions are organized into an action queue 118. The queue 118 is dynamic and continuously updated based on on-going observations and the decisions made by the OTA Brain 114. Each iteration of the process result in new actions being introduced into a new action queue 120 reflecting changes in the screen state and evolving considerations of next steps. The iterative approach ensures that the system remains responsive and adaptable to the dynamic nature of the user interface. In the embodiment, a translator component 122 converts the actions from the new action queue 120 into specific I/O commands 124. The commands 124 are detailed directives that correspond to precise coordinates on the screen. Further, the actor component 126 executes the commands 124 performing tasks such as mouse clicks or keystrokes at the designated locations. The execution process translates the abstract natural language instructions into specific input/output command 124 with the help of the user interface. Further, the system performs an update and retrospective analysis 128. The Action Queue 118 is updated to reflect the results of the executed commands, and the retrospective analysis 128 is conducted to evaluate the success of the actions. The analysis 128 helps refine future actions and improve the system's performance. If the Action Queue 118 is empty and no further actions are required, the system concludes the process as ‘done,’ indicating that the user's request has been fully addressed. The results of the executed I/O commands 124 are displayed to the user on the display screen 130. The final display completes the interaction cycle providing the user with feedback on the actions taken and ensuring that the prompt has been effectively addressed.

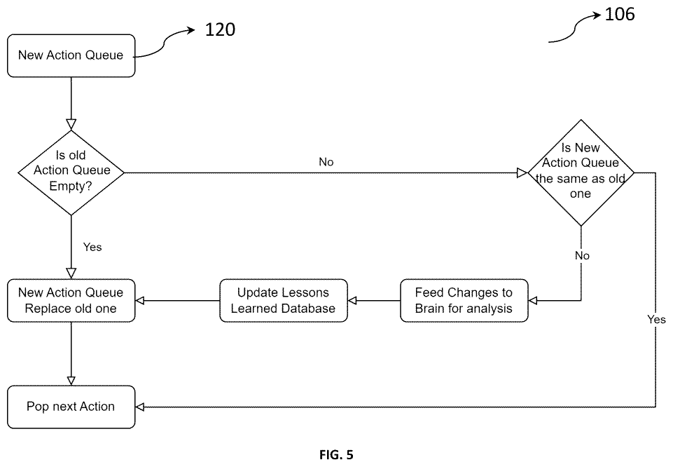

In an embodiment of the present invention, a computer-implemented system employs an advanced observe, think, and act (OTA) architecture 114 (as shown in FIG. 4) to translate natural language instructions into actionable system input/output (I/O) commands. The architecture 114 consists of three core modules i.e. an observe module, a think module and an act module. The observe module acts as the sensory component of the system. The module is configured with sophisticated computer vision technology to capture and analyse various visual elements of a user interface (UI). The module utilizes advanced image processing and recognition algorithms to discern both the spatial arrangement and textual content present on the screen. By creating a comprehensive visual context, the observe Module identifies key UI components such as buttons, text fields, icons and assesses their spatial relationships and textual information. The output from the observe module is then fed into the think module. The think module employs a large language model that utilizes natural language processing (NLP) techniques to interpret the visual context provided by the observe module. The think module then analyses the spatial-textual information to generate actionable language that reflects the user's intent and the system's requirements. Once the think module has generated preliminary instructions, the instructions are passed to the act module. The act module is responsible for refining the natural language instructions by incorporating specific screen coordinates and other spatial information. The refinement process ensures that the instructions are not only contextually relevant but also precisely aligned with the exact locations on the screen where actions are needed. Further, the act module translates the refined instructions into actionable system I/O commands. The conversion involves creating specific directives that target the identified coordinates on the screen, enabling accurate and efficient control of the user interface.

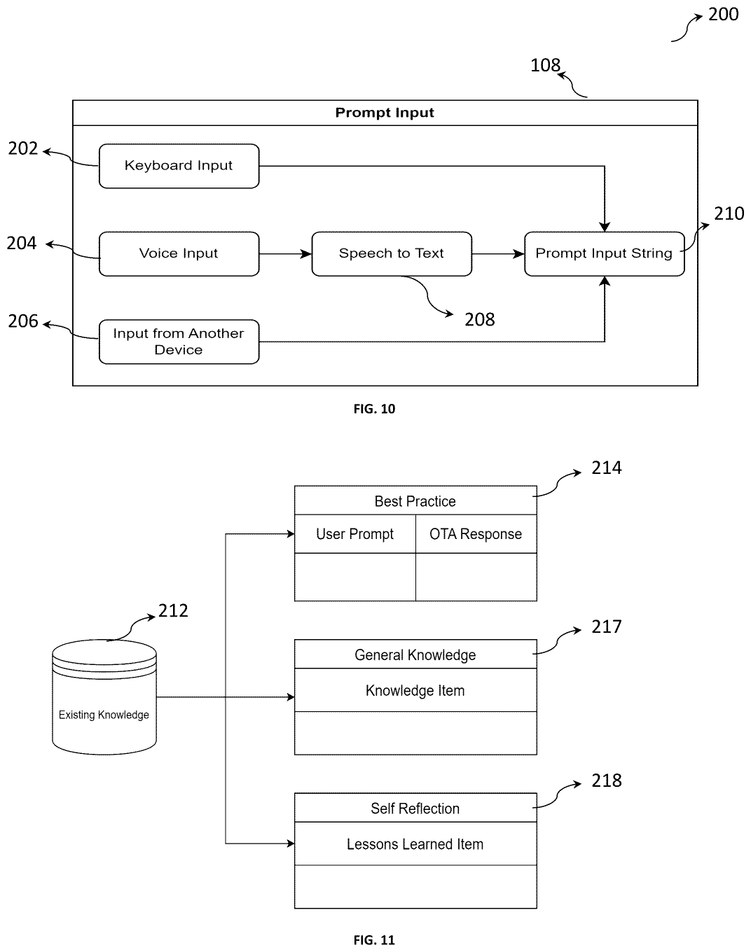

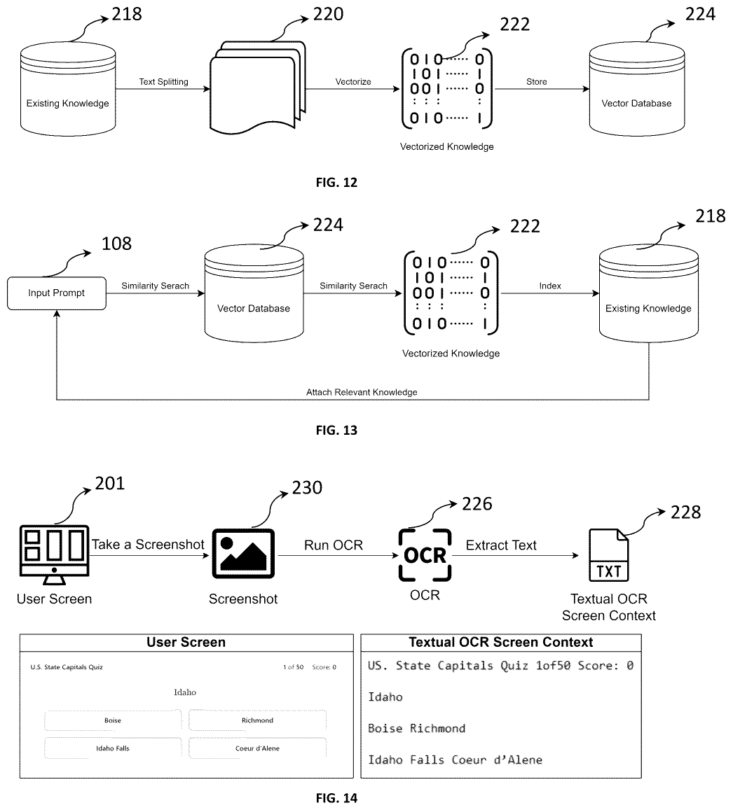

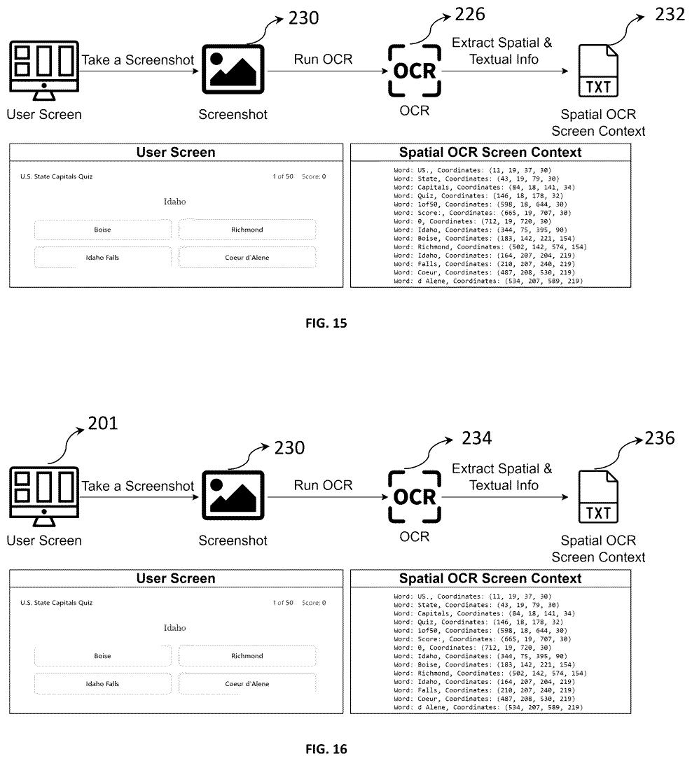

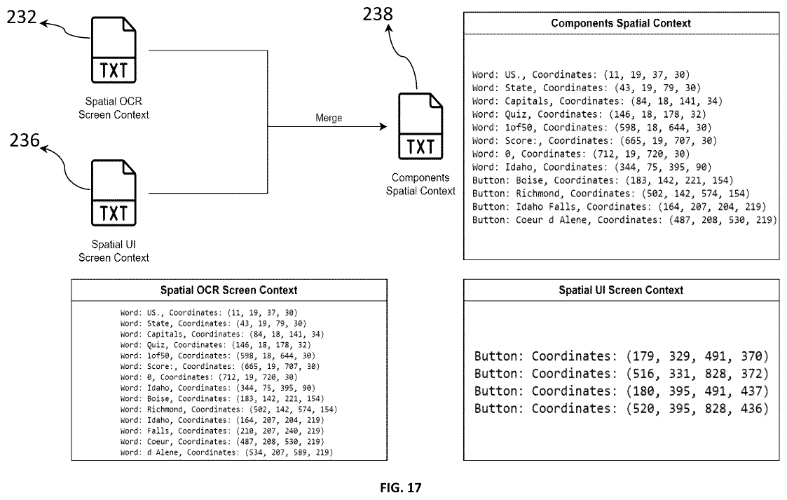

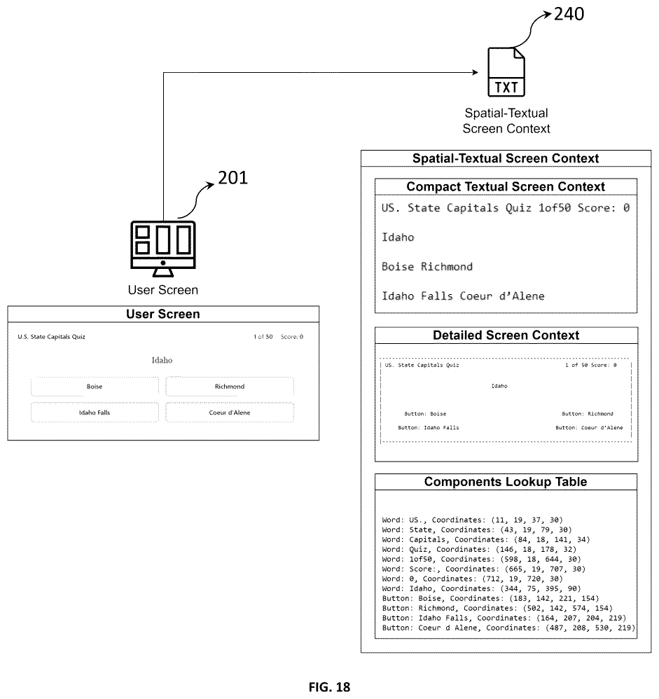

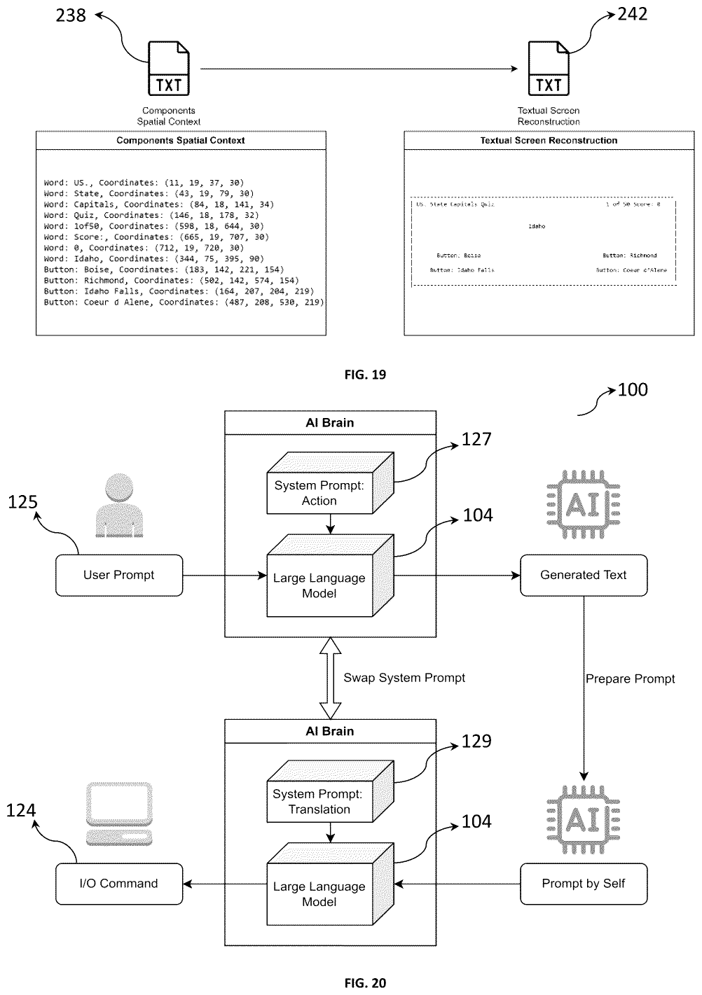

In an embodiment of the present invention, the FIG. 10-FIG. 19 depicts a computer-implemented method for translating natural language instructions into actionable system I/O commands. The FIG. 10 depicts a method that prompt input module 108 for receiving the user instructions from a user interface 201. The module 108 is configured to accommodate inputs from a variety of sources including keyboards 202, voice commands 204, and other devices 206. When voice inputs 204 are detected, they are processed by a speech-to-text conversion module 208 that translates spoken words into a standardized text format, thereby ensuring that all user inputs regardless of their origin are converted into a uniform prompt input string 210 for consistent processing. In addition, the FIG. 11 depicts once the prompt input 210 is standardized, the input is integrated with an existing knowledge module 212 which is organized into three distinct segments stored as CSV files i.e. a Best Practice 214, a General Knowledge 216 and a Self Reflection 218. The Best Practice segment 214 contains optimal procedures and efficient response actions for various different tasks. The General Knowledge segment 216 houses factual data that supports accurate and relevant responses. Meanwhile, the Self Reflection segment 218 offers insights from past interactions which are used for refining the instructions to prevent any misleading results. Further, to facilitate rapid information retrieval, the system employs the existing knowledge 212 as depicted by FIG. 12-FIG. 13. The method involves breaking down of large blocks of text into manageable segments 220 and converting them into a multi-dimensional vector 222. The vectors 222 numerically represent the textual information making it suitable for machine processing. The vectors 222 are then stored in a vector database 224 optimized for high-dimensional data operations. The vector database 224 uses advanced indexing algorithms such as k-d trees and HNSW, along with parallel processing and GPU acceleration to perform swift similarity searches. When user input 108 is converted into vector format 222, it is matched against the database 224 to retrieve relevant information efficiently. Furthermore, the FIG. 14-FIG. 19 illustrates an optical character recognition 226 (OCR) technology configured to convert images into editable text. The OCR process generates multiple contexts including the Textual OCR Screen Context 228 by extracting text from a screenshot 230 of a user interface. The text is extracted quickly but without spatial details that potentially leads to ambiguous results. In the embodiment, the system employs the Spatial OCR Screen Context 232 which is configured to retain both textual and spatial information. The Spatial OCR Screen Context 232 is useful for screen layout reconstruction by employing large language models. In addition, to enhance spatial understanding, an Object Detection 234 is applied to identify and locate UI components within images. A Spatial UI Screen Context 236 is configured to capture the arrangement of UI elements like buttons and text fields. The Spatial UI Screen Context 236 combines with the Spatial OCR Screen Context 232 to create a comprehensive Components Spatial Context 238 which encompasses textual information, UI component details, and spatial coordinates. The Components Spatial Context 238 is stored in a Components Lookup Table for efficient querying. With the Components Spatial Context 238, the system moves from spatial-textual screen context 240 to Textual Screen Reconstruction 242 simulating the spatial layout in a text format that preserves UI element spacing and types. The reconstruction 240 provides a clearer representation of generating the detailed screen context from the reconstructed text, offering an in-depth view for complex screen analysis.

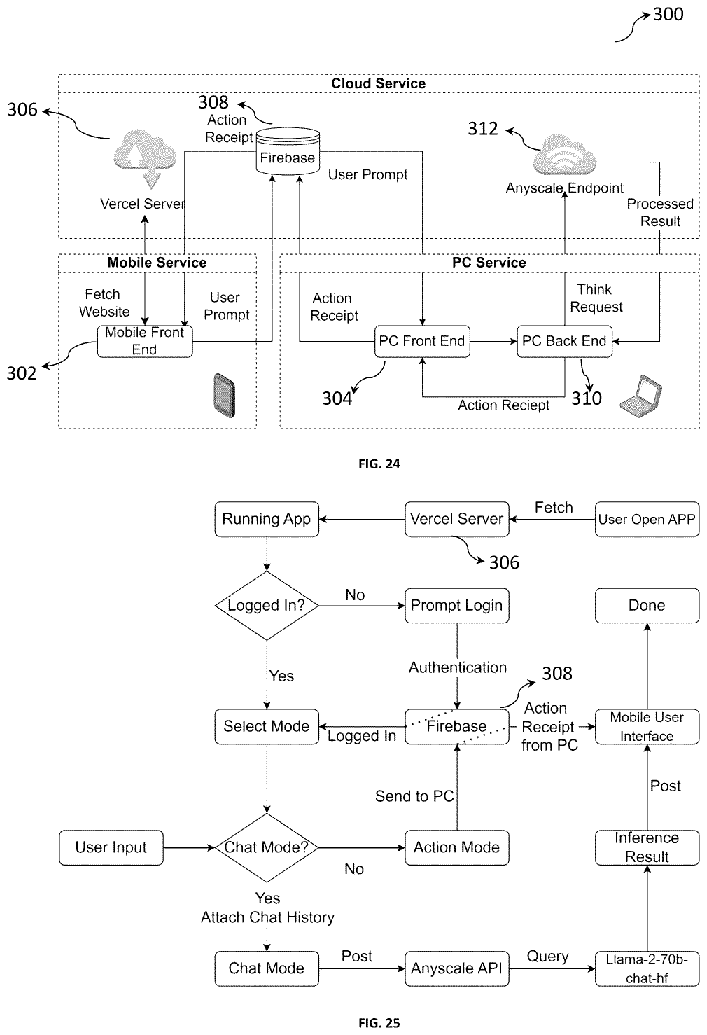

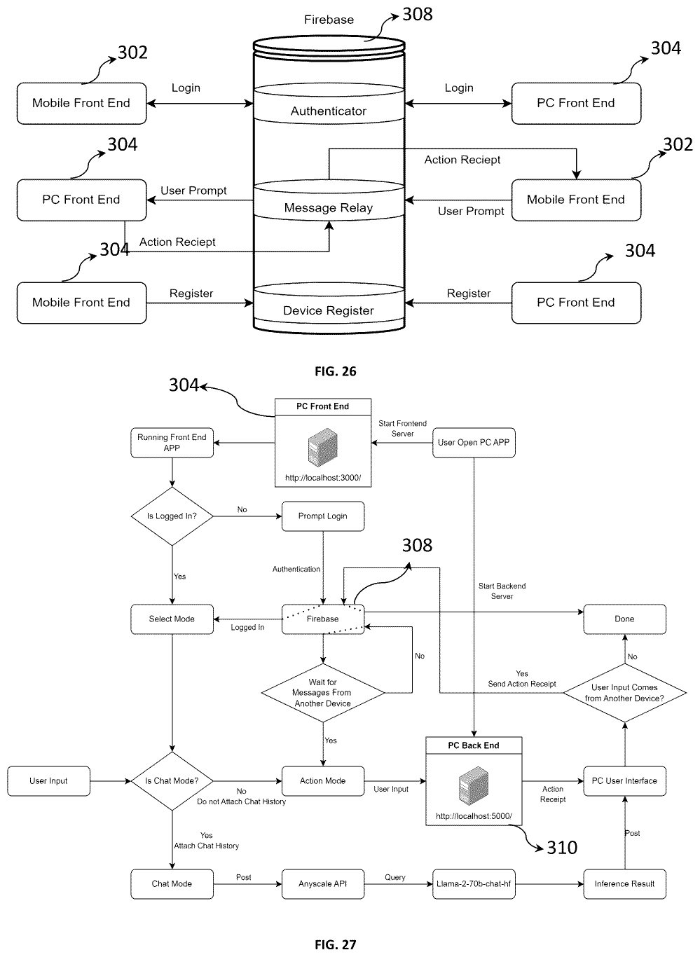

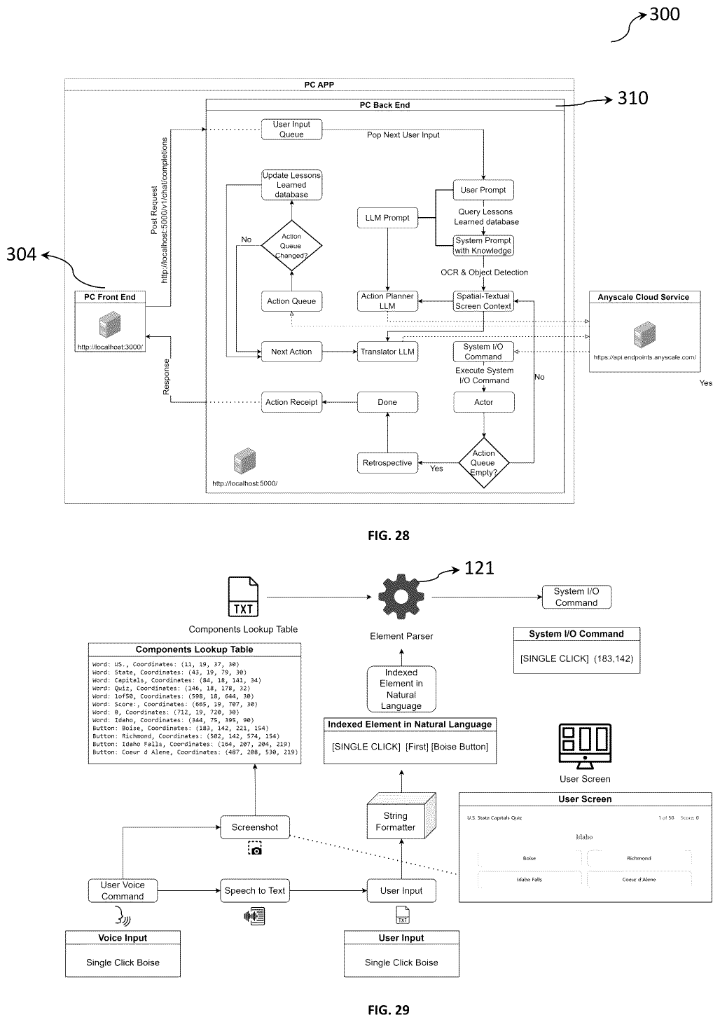

In an embodiment of the present invention, the FIG. 24-FIG. 28 illustrates a computer-implemented software implementation for translating instructions into commands. The software system 300 seamlessly integrates diverse technological components to deliver a highly efficient and interactive user experience across multiple platforms. The software system 300 includes a React-based user interface component configured to provide a cross-platform experience that seamlessly handles the input of natural language instructions. The component is pivotal in capturing user input and displaying the results of translated system I/O commands on an electronic device that includes smartphone, PDA, tablet, desktop platforms etc. In the embodiment, when a user interacts with an application through a web, a mobile app or desktop client, the user input is processed by a Mobile front end 302 and a PC front end 304. The Mobile front end 302 encapsulates a website within the mobile app that provides cross-platform compatibility and eliminates the need for frequent updates. The web-based approach ensures that any changes to the website are instantly reflected in the mobile app. Moreover, the PC front end 304 operates locally on a desktop which is configured to offer a robust user interface for PC use. Both the mobile 302 and PC front end 304 rely on an APIs to communicate with the backend ensuring that data flows seamlessly between the user interface and the software. In the embodiment, the backend operations are driven by a robust python service. The python manages a variety of essential tasks including data processing, computer vision, system I/O tasks, and server interactions. Further, to enhance the processing of natural language instructions a Lang Chain module is integrated to optimize memory management and text embedding's. The Lang Chain facilitates effective inference with a large language models (LLMs) to allow the user commands to accurately interpret and translate inputs into actionable system I/O commands. In the embodiment, the system's capability for fast and accurate similarity searches is powered by a Faiss component. The Faiss component manages large-scale vector data by performing clustering and similarity searches that are crucial for matching query vectors with the stored vectors. For visual data analysis, the software utilizes a tesseract OCR to extract text from images. The Optical Character Recognition component enables the software to process and interpret textual content by capturing screen content, thus allowing the component to understand the visual data effectively. A YOLO object detection module is configured to provide real-time detection of various user interface elements. The YOLO's module provides an advantageous feature by analysing images simultaneously, thus improving the system's interaction with graphical user interface to identify and classify interface components such as buttons and icons. The API's facilitates connectivity with cloud-based services, extending the system's functionalities. The cloud hosting and server management are handled by a Vercel Server 306 that is deployed to scale the web application to ensure that updates are synchronized with the code repositories. On the mobile front, the application encapsulates a web interface within a mobile application framework. A Firebase 308 supports the functionality by managing user authentication, device registration, and cross-device message communication. The firebase 308 ensures that users have secure access to their accounts and that messages are reliably transmitted across devices. A PC back end 310 complements the desktop front-end by processing complex task including OCR, object detection, and system I/O command execution. The PC back end 310 interacts with an Any scale Endpoints 312 to access a suite of Large Language Models (LLMs) tailored for various processing needs. In the embodiment, to translate natural language instructions into actionable system commands, the system employs an Intelligent Indexing Template. The template formats commands in a structured manner, enhancing the accuracy and clarity of command execution. A Self Reflection Template allows the software to review completed actions, analyse performance and generate new knowledge. The self-reflection mechanism continuously updates the Lessons Learned Database to provide improvements in system performance and functionality.

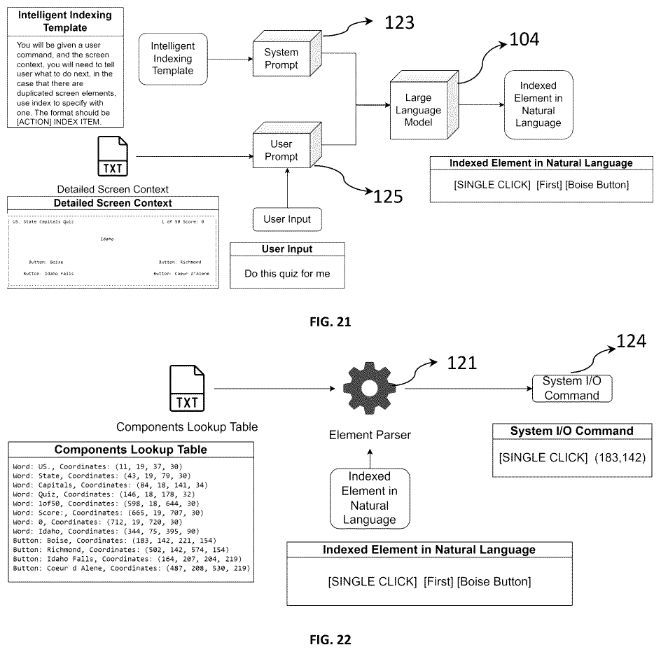

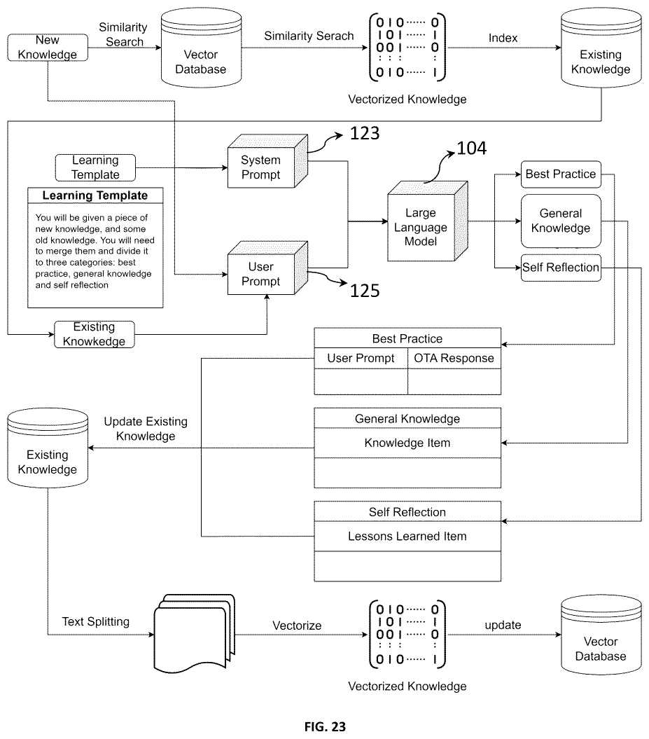

In an exemplary embodiment as illustrated in FIG. 21-FIG. 24 AND FIG. 29, the Translator 122 employs an Element Parser 121 which is implemented using a large language model (LLM) 104 with a tailored system prompt 123 and a user tailored prompt 125. Instead of relying on a traditional string-based parser, the LLM 104 interprets natural language instructions directly. The system prompt 123 guides the LLM to understand the context of the instruction, identify key elements, and generate precise system I/O commands. For example, if the instruction is “Click the first button,” the LLM 104 outputs a command like [Single Click] [First] [Button] that effectively converts the instruction into I/O commands 124 for the system.

In an exemplary embodiment, the FIG. 20 depicts control behaviour prompt. A large language model (LLM) 104 is an advanced AI tool designed to handle and generate human-like text based on natural language input. The LLM interpret and respond to user prompts with contextually appropriate context, effectively allowing it to think, reason, and communicate in a manner similar to human conversation. A user prompt 125 refers to the specific input provided by users, which can range from straightforward questions to intricate requests for explanations or problem-solving. The prompt 125 drives the AI's immediate response and reflects the user's particular need. Unlike the user prompt 125, a system prompt is a foundational set of instructions pre-configured by developers or operators. To manage the AI's response behaviours, the system prompt can be dynamically altered. In an action mode 127, the system prompt directs the AI to break down complex user requests into smaller manageable action items which are then queued for processing. In a translation mode 129, the system prompt shifts to a translation template that converts the action items into specific system I/O commands 124 based on the current screen context.

In one of the embodiment of the present invention, a triage model is a variant of the LLM with around 7 billion parameters which is utilized for initial triaging of user inputs. It categorizes inputs into action or translation types. The model is designed for speed and efficiency but is less accurate. The approach ensures that user inputs are effectively managed and translated into appropriate actions or commands within the system.

In one of the embodiment of the present invention, a speed optimized model such as Mistral-7B-v0.1 or Zephyr-7b-beta involves around 7 billion parameters and is configured to swiftly break down simple user requests into actionable items. In addition, a task optimized model is fine-tuned on task-specific data like chat history or domain knowledge to handle specialized tasks effectively. Further, a performance optimized models having approximately 70 billion parameters offer more thorough reasoning and is used for complex requests that demand higher intellectual capabilities. A chat optimized models are similarly trained on chat data to ensure adherence to communication standards and a Logic Optimized Models is configured to get trained on the complex logic data so that it can handle advance reasoning and complex instruction.

In one of the embodiments of the present invention, the integration of the user interface, backend service, language models, OCR, and object detection modules, along with API and cloud service interactions collectively contribute to the accurate translation of natural language instructions into precise system I/O commands, elevating the efficacy and intuitiveness of human-computer interaction.

In one of the embodiments of the present invention, integration of advanced computational techniques represents a significant contribution to the field of artificial general intelligence, enabling a more nuanced and contextually aware interpretation of natural language instructions.

In one of the embodiment of the present invention, the computer-implemented method enhances human-computer interaction by enabling a seamless collaboration between the computer vision module and the language model, resulting in a more intuitive and efficient user experience.

In one of the embodiment of the present invention, the system I/O commands generated are particularly suited for facilitating interaction with computer interfaces for individuals with disabilities, thereby expanding accessibility and usability of technology.

It should be understood that the examples provided herein are intended only for purposes of illustration and any number of other implementations is also contemplated. Additionally, the referenced examples (including the described rules and/or other techniques) can be combined in any number of ways.

Although an overview of the inventive subject matter has been described with reference to specific example implementations, various modifications and changes can be made to those implementations without departing from the broader scopes of implementation of the present disclosure. Such implementation of the inventive subject matter can be referred to herein, individually or collectively, by the term “invention” merely for convenience without intending to voluntarily limit the scope of this application to any single disclosure or inventive concept if more than one is, in fact is disclosed.

The implementations illustrated herein are described in sufficient detail to enable those skilled in the art to practice the teachings disclosed. Other implementations can be used and derived therefrom, such that structural substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources or structures described herein as a single instance. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A computer-implemented method for translating natural language instructions into system input and output (I/O) commands, the method comprising:
configuring an advanced computer vision module to capture and analyse a plurality of visual elements of a user interface of an electronic device to create a comprehensive visual context by understanding the spatial layout and textual content of the user interface;
providing the captured data from the computer vision module into an advanced language model configured to generate a natural language description of potential actions tailored to the current context of the user interface;
generating natural language instructions from the language model analysis to specify actions aligned with the current context and user needs;
refining the generated natural language instructions by incorporating a specific screen coordinate to ensure both contextual relevance and spatial accuracy;
translating the refined natural language instructions into a precise system I/O commands;
wherein the system I/O commands include actionable directives at the specific screen coordinates configured to enable intuitive and efficient control of the user interface through natural language instructions.

2. The computer-implemented method of claim 1, wherein the computer vision module and the language model operate collaboratively to interpret and interact with the user interface, enhancing the overall efficiency and intuitiveness of human-computer interaction.

3. The computer-implemented method of claim 1, wherein the system I/O commands generated are particularly suited for facilitating interaction with a computer interface for individuals with disabilities, thereby expanding accessibility and usability of technology.

4. The computer-implemented method of claim 1, wherein the integration of computer vision and language processing represents advancement in the field of artificial general intelligence, providing a framework for transforming complex linguistic instructions into concrete system actions applicable across various technological domains.

5. A computer-implemented system for translating natural language instructions into executable system input/output (I/O) commands using an Observe, Think, Act (OTA) Architecture, the system comprising:
an observe module configured to capture and analyse a plurality of visual elements of a user interface via a computer vision module, the module configured to understand the spatial layout and textual content of the user interface;
a think module with an advanced language model configured to process visual information from the observe module and generate a natural language descriptions based on the user interface context and a spatial-textual screen information;
an act module configured to refine a natural language instructions from the think module using a specific screen coordinates and translating the refined instructions into precise system I/O commands with actionable directives at the specified screen coordinates; and
wherein the OTA architecture enables the system to interpret and interact with the user interface, enhancing human-computer interaction by converting complex linguistic instructions into concrete system actions in a contextually relevant and spatially accurate manner.

6. The computer-implemented system of claim 5, wherein the computer vision component or module in the Observe module utilizes advanced image processing and recognition algorithms to accurately capture and interpret the visual elements of the user interface.

7. The computer-implemented system of claim 5, wherein the language model in the Think module employs natural language processing techniques to understand and generate instructions based on the visual information and contextual understanding of the user interface.

8. The computer-implemented system of claim 5, wherein the Act module executes system I/O commands based on the synthesized information from the Observe and Think modules, enabling precise and efficient control of the user interface through natural language instructions.

9. The computer-implemented system of claim 5, wherein the OTA Architecture is particularly beneficial for facilitating accessible interaction with computer interfaces for individuals with disabilities, broadening the usability of technology through natural language-based control.

10. A computer-implemented software for translating natural language instructions into executable system input/output (I/O) commands, the software comprising:
a user interface component developed with React configured to provide a cross-platform interface for inputting natural language instructions and displaying the results of a translated system I/O commands;
a backend service coded in Python configured to integrate a data processing, a computer vision tasks, a system I/O tasks and a server interactions;
an language model integrated via a Lang Chain configured to optimize memory management, process text embedding efficiently and facilitate effective LLM inference, enhancing accurate interpretation of natural language instructions;
a similarity search and clustering component using Faiss configured to enable the software to perform fast and accurate similarity searches within large-scale vector data for matching a query vector with a stored vector in a vector database;
an optical character recognition (OCR) component employing a tesseract OCR for the extraction of text from images, the OCR allows the software to analyze and process textual content of a captured screen and enhance its interaction with visual data;
an object detection module using Yolo for the real-time detection of various user interface elements, improving the software's ability to interact with and understand graphical user interfaces;
an API integration facilitating communication between a front-end user interface and the backend service, and enabling connectivity with cloud-based services for extended functionalities;
a cloud hosting and server management utilizing Vercel server for deploying and scaling the web application, ensuring up-to-date synchronization with code repositories for continuous integration and delivery;
a mobile application functionality encapsulating a web interface within a mobile application framework configured to support a Fire base for user authentication, device management, and cross-device message communication;
a PC back end configured to process complex tasks and execute optical character recognition (OCR), object detection, and system I/O commands, backed by a Anyscale endpoints for accessing Large Language Model services;
integration of various optimized language models includes speed-optimized, task-optimized, and performance-optimized models tailored to specific requirements of the software in processing and translating natural language instructions into system I/O commands;
uilization of an Intelligent indexing template to enable the software to translate natural language instructions into specific I/O commands in a formatted manner to enhance the precision and clarity of command execution; and
a self-reflection mechanism incorporated through a self-reflection template configured to allow the software to analyze completed actions and generate a new knowledge and update the Lessons Learned Database for continuous improvements.

11. The computer-implemented software of claim 10, wherein the integration of the user interface, backend service, language models, OCR, and object detection modules, along with API and cloud service interactions, collectively contribute to the accurate translation of natural language instructions into precise system I/O commands, elevating the efficacy and intuitiveness of human-computer interaction.

12. The computer-implemented software of claim 10, wherein modular design and component-based architecture enable adaptability and customization, allowing for seamless integration with various technologies and platforms, thereby broadening the applicability of the software in diverse technological domains.

13. The computer-implemented software of claim 10, wherein the integration of advanced computational techniques represents a significant contribution to the field of artificial general intelligence, enabling a more nuanced and contextually aware interpretation of natural language instructions.
